(19) United States
(12) Patent Application Publication
(10) Pub. No.: US 2010/0271488 A1
(43) Pub. Date: Oct. 28, 2010

(54) Method for detecting corrupted payload in a serial digital interface video stream

(75) Inventors: Oscar Garcia, Garland, TX (US); Peter J. O'Connell, Heath, TX (US); Charles Shelton, Frisco, TX (US)

Correspondence Address: ALCATEL-LUCENT, C/O GALASSO & ASSOCIATES, LP, P. O. BOX 26503, AUSTIN, TX, 78755-0503, US

(73) Assignee: Alcatel-Lucent USA Inc.

(21) Appl. No.: 12/798,724

(22) Filed: Apr. 9, 2010

Related U.S. Application Data
(60) Provisional application No. 61/214,308, filed on Apr. 22, 2009.

(51) Int. Cl. H04N 17/00; H04N 7/173

(52) U.S. Cl. 348/180; 725/107; 348/E17.001

(57) ABSTRACT

The preferred method involves the use of an embedded data field within the video stream to transport a predetermined/known source string of data which in normal operation is carried intact through the entire head-end, grooming, distribution and access portions of the provider's network. An element or multiple elements are positioned at one or more points in the network. The elements continually monitor the stream to verify that a predetermined data string is located in the embedded data field.

### CROSS REFERENCE TO RELATED APPLICATIONS

This United States non-provisional patent application claims priority to U.S. provisional patent application No. 61/214,308 entitled “Method for Detecting Corrupted Payload in a Serial Digital Interface Video Stream” filed on Apr. 22, 2009.

### FIELD OF THE DISCLOSURE

The disclosures made herein relate generally to the telecommunications industry. The invention discussed herein is in the general classification of a device, system and method for detecting corrupted payload in a serial digital interface video stream.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Several technical terms will be used throughout this application and merit a brief explanation.

Serial Digital Interface (SDI) is a group of video interfaces that has been standardized by the Society of Motion Picture and Television Engineers (SMPTE). Video payload may use any 10-bit value in the range 4 to 1019; however, the values 0-3 and 1020-1023 are reserved for synchronization packets and ancillary data headers and may not appear in the payload.

Ancillary data is non-video payload embedded within a serial digital signal. It is used for embedded audio, closed captions, timecode and other sorts of metadata. Ancillary data ordinarily appears in an ancillary (ANC) data packet such as a vertical ancillary (VANC) data packet or horizontal ancillary (HANG) data packet.

Video on Demand (VOD) programming permits users to view video or listen to audio whenever desired. VOD permits a user to utilize a set-top box to receive a content stream and view it in real time or to utilize a computer or digital video recorder (DVR) to download a program and view it subsequently.

Head end refers to the location in a network where television signals are received for processing and distribution.

Middleware connects two software applications that may be running on separate machines in different parts of a network.

Encryption is used to protect data as it travels through a network by making it unreadable to those not possessing the ability to perform decryption.

Digital Rights Management (DRM) is a set of access control technologies used to limit the ability to use or copy digital content for purposes not authorized by the content provider.

Service Provider is an entity that usually provides Internet or mobile phone services to businesses and individuals.

A residential gateway is a home networking device that connects other home devices to the Internet and may involve a router/modem.

Internet Protocol Television (IPTV) is a system for delivering digital television service using the architecture and networking methods of Internet Protocol (IP) over a packet-switched network.

A passive optical network (PON) is fiber to the premises network architecture in which optical splitters allow a single optical fiber to serve multiple subscribers. A PON includes an optical line terminal (OLT) which is at the service provider's central office and a number of optical network terminals (ONTs) located near end users. A BPON is a broadband PON for higher upstream bandwidth allocation and a GPON is a gigabit PON, supporting higher data rate transfers.

A digital subscriber line multiplexer (DSLAM) can be a network device located in the telephone exchanges of service providers for connecting multiple digital subscriber lines (DSLs) to the Internet using multiplexing techniques.

Video distribution networks are made up of a number of active elements that perform various grooming functions to a video stream. These elements can include, but are not limited to, devices that amplify, decode, synchronize and re-encode the video stream and devices that insert additional audio/video content. Any one of these elements can enter a defective operational state, either permanently or temporarily, that results in the element outputting a corrupted video stream.

Currently, there is no automated method for distinguishing between an intact video signal and a corrupted video signal. Computer monitoring for the presence of data in the video frame is ineffective for detecting corrupted or frozen video streams and is not economically practical to deploy in a manner that isolates the defective element. Utilizing human monitoring for every stream is expensive and somewhat impractical.

Hence, there is a need for a device, system and method for detecting a corrupted video stream that notifies the service provider of the location of the corrupted video stream in the network to permit the offending element that created the corrupted video stream to be repaired.

### SUMMARY OF THE DISCLOSURE

The preferred method involves the use of an embedded data field within the video stream to transport a known/predetermined source string of data which in normal operation is carried intact through the entire head-end, grooming, distribution and access portions of the provider's network. An element or multiple elements (stand alone video test probes) containing the receiver/video test probe application are positioned at one or more points in the network and/or any/all of the serial digital interface elements contain the receiver/video test probe application to create integrated video test probes. The video test probes continually monitor the stream for a data string in the embedded field that matches the predetermined data string.

Because the predetermined data string is carried within the video stream, when the video stream is corrupted, the predetermined data string is also corrupted. The detection of a corrupted data string generates an alarm event which can be used to initiate protective actions within the network. By deploying multiple video test probes, the operator has the ability to determine the location of the fault.

The code generator is a software application that can run in any computer environment (i.e. an element) and generates the predetermined data string and inserts it into the embedded data field of the video stream.

The receiver/video test probe application is a software application that can run in any computer environment (i.e. an element) and extracts the data string from the embedded data field and compares the read data to the expected/predetermined data. If they do not match, an alarm is generated.

The embedded data field or designated data field is one of the unused and/or reserved for future use fields of a Vertical Ancillary (VANC) data packet or Horizontal Ancillary (HANC) data packet as defined in Society of Motion Picture and Television Engineers (SMPTE) 291, SMPTE 334M or SMPTE 125M.

The preferred system involves the use of satellite dishes streaming programming to the head end for media grooming where the predetermined data string can be inserted into the designated data field of the ancillary data packets via software contained in stand alone equipment/elements or through the use of software running on video head end elements. The ancillary data packets can then be sent through head end elements and middleware elements and/or stand alone equipment/elements in the head end and the center of the network that contain software to monitor the data string in the designated data field before being sent to the residential gateway and onto the IPTV client.

The preferred device involves a memory containing a set of instructions and a processor for processing the instructions for inserting a predetermined data string into a designated data field of an ancillary data packet and/or reading a data string located in the designated data field and comparing the data string to the predetermined data string for the designated field.

Under some applications, embodiments may provide a method and system that are relatively inexpensive to implement that detect corrupted payload in a serial digital interface video stream.

Under some applications, embodiments may provide a device, system and method that are not operationally complex that detect corrupted payload in a serial digital interface video stream.

Under some applications, embodiments may provide a device, system and method that can automatically detect corrupted payload in a serial digital interface video stream.

Under some applications, embodiments may provide a device, system and method that efficiently detect corrupted payload in a serial digital interface video stream.

Under some applications, embodiments may provide a reliable device, system and method to detect corrupted payload in a serial digital interface video stream.

Under some applications, embodiments may provide a device and system that are relatively inexpensive to manufacture and deploy that detect corrupted payload in a serial digital interface video stream.

### BRIEF DESCRIPTION OF THE DRAWINGS

Some embodiments of apparatus and/or methods of the present invention are now described, by way of example only, and with reference to the accompanying drawings, in which:

FIG. 1 schematically illustrates a system for providing corrupted video detection through insertion of a predetermined data string in a designated data field of an ancillary data packet and monitoring of the designated data field in various elements.

FIG. 2 schematically illustrates the head end elements of the system of FIG. 1.

FIG. 3 schematically illustrates the elements running middleware and delivery elements of FIG. 1.

FIG. 4 depicts the method of the preferred embodiment for inserting a predetermined data string into a designated data field of an ancillary data packet.

FIG. 5 depicts the method of the preferred embodiment for monitoring the designated data field of the ancillary data packets.

FIG. 6 depicts the device of the preferred embodiment capable of inserting a predetermined data string into a designated data field of an ancillary data packet and/or reading and comparing the data string in the designated data field to the predetermined data string.

### DETAILED DESCRIPTION OF THE DRAWINGS

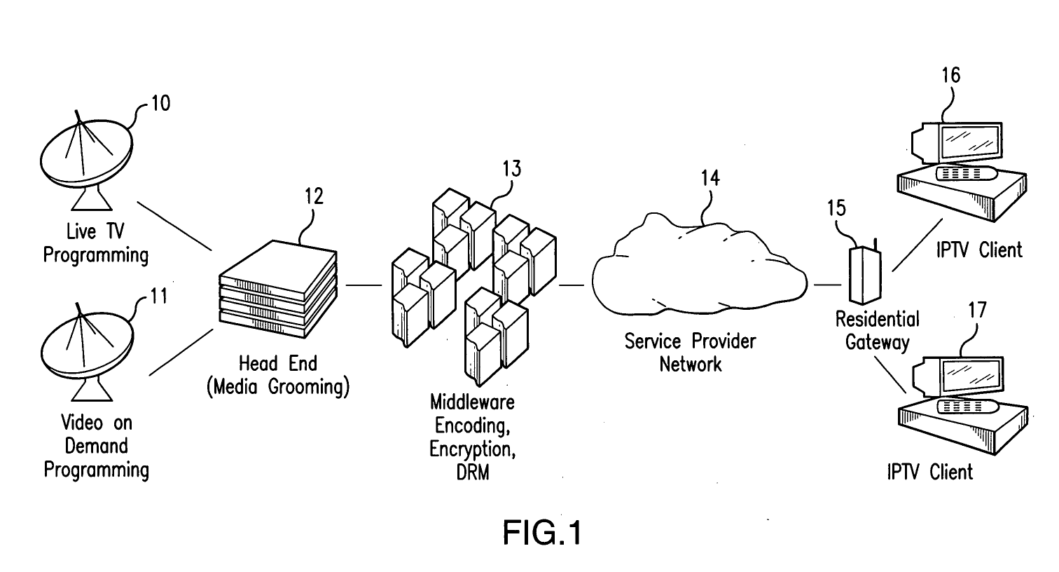

FIG. 1 schematically illustrates a system for providing corrupted video detection through insertion of a predetermined data string in a designated data field of an ancillary data packet and monitoring of the designated data field in various elements. A live television (TV) programming satellite dish 10 and a video on demand programming satellite dish 11 transmit programming to the head end equipment/elements 12.

The head end equipment/elements 12 receive the programming and perform a variety of media grooming functions. The head end equipment/elements 12 may insert a known/predetermined data string into a designated data field in the received ancillary data packets. This predetermined data string serves to identify the data packet as containing uncorrupted data and is known to all elements in the network running the appropriate software. The head end equipment/elements 12 then transmit the ancillary data packets to the middleware elements 13 (i.e. elements running middleware). The middleware elements 13 may detect/inspect a data string in the embedded/designated data field to insure that the data string corresponds to the predetermined data string. The middleware elements 13 can still provide encoding, encryption and digital rights management functions and send the ancillary data packets on to the service provider network 14 where they can be delivered to the residential gateway 15 and then to the appropriate IPTV client (16 or 17).

Typically, horizontal ancillary (HANC) data packets are permitted immediately after any end of active video (EAV) data packet. Vertical ancillary (VANC) data packets are permitted immediately after any start of active video (SAV) data packet on a line containing neither active picture nor digitized ancillary data. Ancillary (ANC) data packets typically consist of fields for an ancillary data flag (ADF), the data ID (DID), the secondary data ID (SDID), the data count (DC), the user data words (UDW) and the checksum (CS). The DID field and the SDID field are two examples of data fields that could be provisioned/designated for insertion of the predetermined data string.

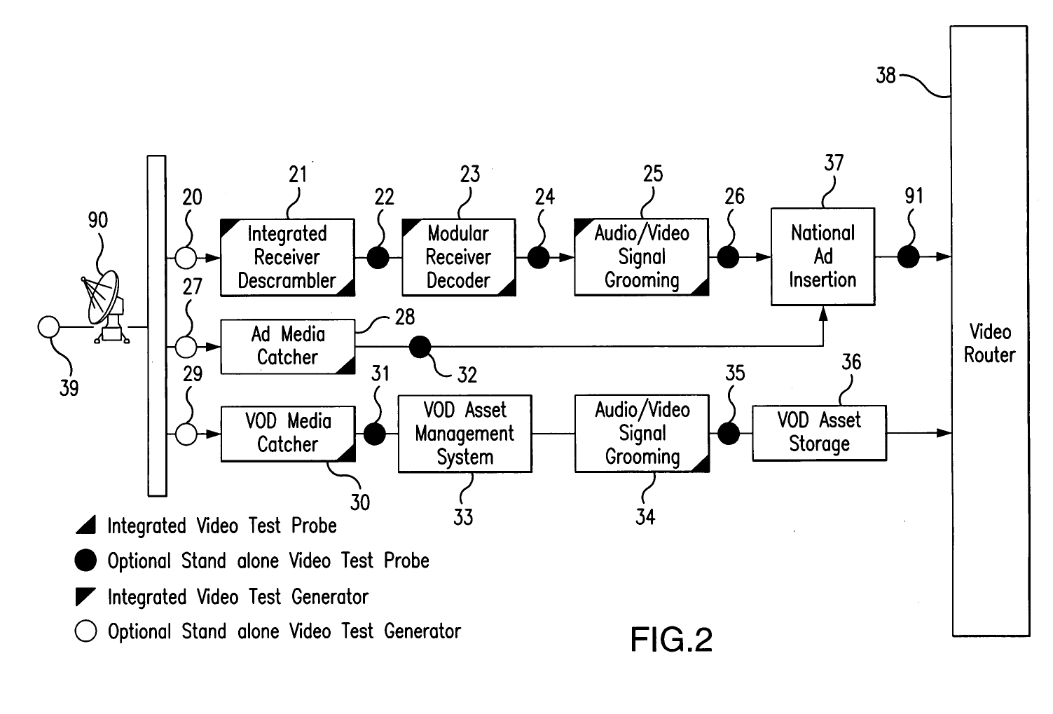

FIG. 2 schematically illustrates the head end elements of the system of FIG. 1. An optional stand alone video test generator 39 is connected to a satellite dish 90 for broadcasting live or on demand video programming. A variety of elements or equipment may be located in the head end. Elements can be connected either directly or through other elements. For example, two elements are connected if a data packet can be sent from one to the other.

An optional stand alone video test generator 20 connects to an integrated receiver descrambler 21 that connects to an optional stand alone video test probe 22. The optional stand alone video test probe 22 connects to a modular receiver decoder 23 that connects to an optional stand alone video test probe 24. The optional stand alone video test probe 24 connects to an audio/video signal grooming module 25 that connects to an optional stand alone video test probe 26 that connects to a national advertisement insertion module 37. The national advertisement insertion module 37 connects to an optional stand alone video test probe 91 that connects to a video router 38. The integrated receiver descrambler 21, the modular receiver decoder 23 and the audio/video signal grooming module 25 may operate as integrated video test probes and/or integrated video test generators in this preferred embodiment.

An optional stand alone video test generator 27 connects to an advertisement media catcher module 28 that connects to an optional stand alone video test probe 32. The optional stand alone video test probe 32 connects to the national advertisement insertion module 37. The advertisement media catcher module 28 may operate as an integrated video test probe in this preferred embodiment.

An optional stand alone video test generator 29 connects to a video on demand media catcher module 30 that connects to an optional stand alone video test probe 31. The optional stand alone video test probe 31 connects to a video on demand asset management system 33 that connects to an audio/video signal grooming module 34. The audio/video signal grooming module 34 connects to an optional stand alone video test probe 35 that connects to a video on demand asset storage module 36. The video on demand asset storage module 36 connects to the video router 38. The video on demand media catcher module 30 and the audio/video signal grooming module 34 may operate as integrated video test probes in this preferred embodiment.

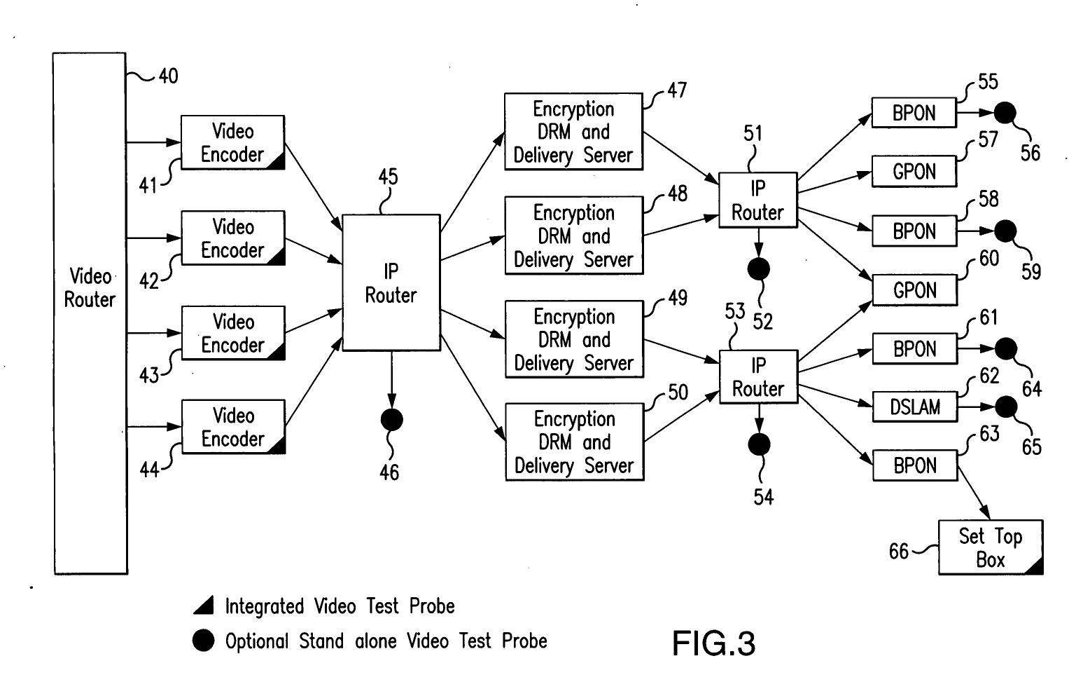

FIG. 3 schematically illustrates the middleware and delivery elements of FIG. 1. A video router 40 connects to video encoders 41, 42, 43 and 44 that each connect to an IP router 45 that also connects to an optional stand alone video test probe 46. The video encoders 41, 42, 43 and 44 may operate as integrated video test probes. The IP router 45 connects to encryption, digital rights management and delivery servers 47, 48, 49 and 50. Servers 47 and 48 connect to IP router 51 that also connects to an optional stand alone video test probe 52. Servers 49 and 50 connect to IP router 53 that also connects to an optional stand alone video test probe 54.

IP router 51 connects to BPON 55 and BPON 58 and GPON 57 and GPON 60. BPON 55 connects to optional stand alone video test probe 56 and BPON 58 connects to optional stand alone video test probe 59.

IP router 53 connects to GPON 60, BPON 61 and BPON 63. IP router 53 also connects to DSLAM 62. BPON 61 also connects to optional stand alone video test probe 64 and DSLAM 62 also connects to optional stand alone video test probe 65. BPON 63 connects to set top box 66 which may operate as an integrated video test probe.

The arrangement of equipment/elements in FIG. 2-3 permit the predetermined data string to be inserted into the designated data field of the ancillary data packets either before being sent for broadcasting or before arrival at the various head end elements/equipment or while at the various head end elements/equipment. This arrangement also allows various points for the data string in the designated data field to be inspected to detect corruption of data through the use of software either integrated into the usual serial digital interface elements/equipment or through the use of stand alone elements/equipment located in the head end, center or other area of the network.

A video test generator is an element (e.g. server, computer, module or other equipment) capable of receiving ancillary data packets, inserting the predetermined data string into the received ancillary data packets in the designated data field and sending ancillary data packets. An optional stand alone video test generator is a video test generator in an optional location in the network that does not perform any other tasks in the network other than those of a video test generator, but it is not necessary that any/all of the optional stand alone video test generators appear in any/all of the locations shown in FIG. 2. An integrated video test generator is a serial digital interface element such as a receiver/descrambler, decoder, audio video signal groomer, advertisement media catcher module, video on demand media catcher module or storage device that is also capable of performing the tasks of a video test generator. As would be apparent to one skilled in the art, it is only necessary that one video test generator (optional or integrated) appear in the described system.

A video test probe is an element capable of receiving ancillary data packets, reading a data string in the designated data field of the received ancillary data packets and comparing the data string in the designated data field with the predetermined data string for the designated data field. A video test probe typically also is capable of generating an alarm stimulus signal if the data string located in the designated data field is not a match with the predetermined data string for the designated data field. Generating an alarm stimulus signal may include notifying a service provider through a message sent or other means that the data string in the designated data field is not a match with the predetermined data string. A video test probe is also capable of sending the ancillary data packets to the next elements in the network.

An optional stand alone video test probe is a video test probe located at an optional location in the network that does not perform any other tasks in the network other than those of a video test probe, but it is not necessary that any/all of the optional stand alone video test probes appear in any/all of the locations shown in FIGS. 2-3. An integrated video test probe is a serial digital interface element such as a receiver/descrambler, decoder, audio video signal groomer, advertisement media catcher module, video on demand media catcher module, video encoder, set top box or other functional device that is also capable of performing the tasks of a video test probe. Although it is only necessary for one video test probe (stand alone or integrated) to appear in the system, a larger number of video test probes will permit a service provider to better determine where in the system data is being corrupted.

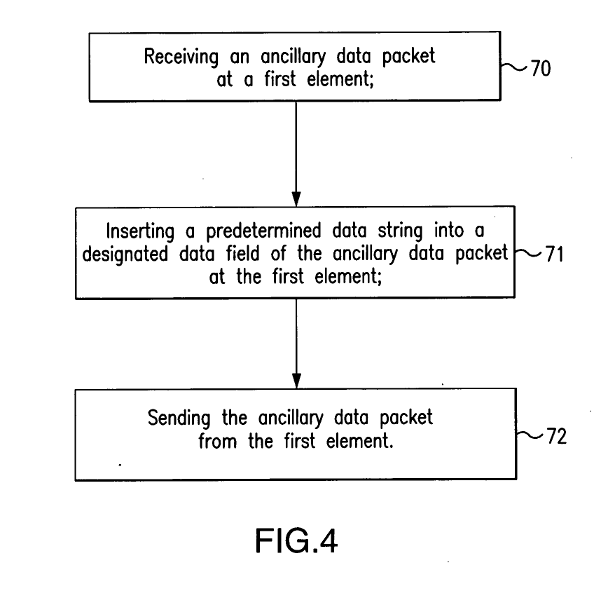

FIG. 4 depicts the method of the preferred embodiment for inserting a predetermined data string into a designated data field of an ancillary data packet. An operation is performed for receiving an ancillary data packet at a first element 70. An operation is performed for inserting a predetermined data string into a designated data field of the ancillary data packet at the first element 71. An operation is then performed for sending the ancillary data packet from the first element 72. These operations may be performed in a variety of elements and equipment located in a variety of locations in a network, including ordinary serial digital interface head end equipment/elements or stand alone equipment/elements located in the head end.

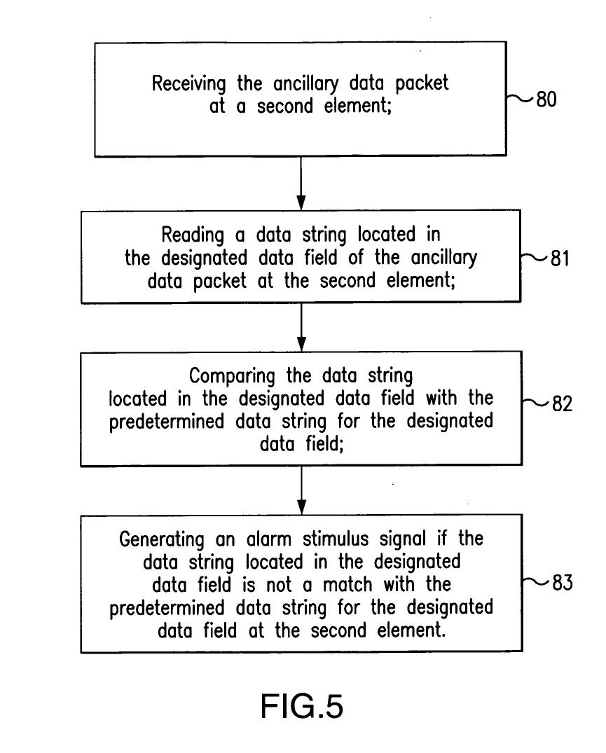

FIG. 5 depicts the method of the preferred embodiment for monitoring the designated data field of the ancillary data packets. An operation is performed for receiving the ancillary data packet at a second element 80. An operation is performed for reading a data string located in the designated data field of the ancillary data packet at the second element 81. An operation is performed for comparing the data string located in the designated data field with the predetermined data string for the designated data field 82. An operation is performed for generating an alarm stimulus signal if the data string located in the designated data field is not a match with the predetermined data string for the designated data field at the second element 83.

Generating an alarm stimulus signal can involve notifying the service provider of the lack of a match between the data string and the predetermined data string to indicate potentially corrupted data (e.g. the second element can send a message through the network). This permits the service provider to take appropriate corrective action. The second element can also notify the service provider of the location of the second element to permit appropriate action to be taken (e.g. the second element can send a message related to its location through the network.)

These operations may be performed in a variety of elements and equipment located in a variety of locations in a network, including ordinary serial digital interface head end equipment/elements, stand alone equipment/elements located in the head end, ordinary serial digital interface equipment/elements and/or stand alone equipment/elements located in the center of the network.

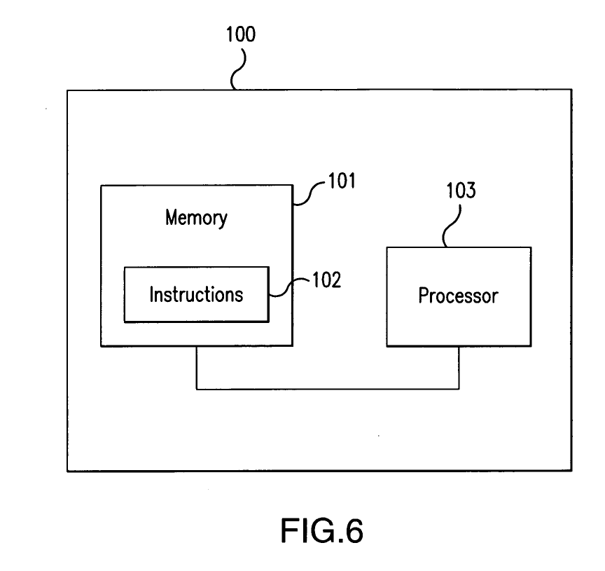

FIG. 6 depicts the device of the preferred embodiment capable of inserting a predetermined data string into a designated data field of an ancillary data packet and/or reading and comparing the data string in the designated data field to the predetermined data string. A memory 101 contains a set of instructions 102 for inserting a predetermined data string into a designated data field of an ancillary data packet and for reading a data string located in the designated data field and comparing the data string to the predetermined data string for the designated data field. A processor 103 is used to process the set of instructions 102.

In certain embodiments, the memory could contain instructions for either inserting the predetermined data string or for reading and comparing the data string to the predetermined data string. Alternatively, the set of instructions could permit the device to insert a predetermined data string when the designated data field is empty and to read and compare the data string to the predetermined data string when the designated data field is full. When the designated data field is full and the read data string does not match the expected/predetermined data string, the device could also have instructions for generating an alarm stimulus signal or for otherwise notifying the service provider.

It is contemplated that the method described herein can be implemented as software, including a computer-readable medium having program instructions executing on a computer, hardware, firmware, or a combination thereof. The method described herein also may be implemented in various combinations on hardware and/or software.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or taps, hard drives, or optically readable digital data storage media. The embodiments are also intended to cover computers programmed to perform said steps of methods described herein. Accordingly, elements running the software usually will have a memory for storing software instructions and a processor for processing these instructions.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A method for use in detecting a corrupted video stream in a network comprising the steps of
(a) receiving an ancillary data packet at an element; and
(b) inserting a predetermined data string into a designated data field of the ancillary data packet at the element.

2. The method of claim 1 further comprising the step of:
sending the ancillary data packet with the predetermined data string in the designated field from the element.

3. The method of claim 1 wherein the element is located in a head end of the network.

4. The method of claim 1 wherein the element is a stand alone video test generator.

5. The method of claim 1 wherein the element is selected from a group consisting of a receiver descrambler, a modular receiver decoder, a video on demand catcher module and an audio/video signal grooming module.

6. A device for use in detecting a corrupted video stream in a network comprising:
(a) a memory containing a set of instructions for inserting a predetermined data string into a designated data field of an ancillary data packet; and
(b) a processor for processing the set of instructions.

7. A method for use in detecting a corrupted video stream in a network comprising the steps of:
(a) receiving an ancillary data packet at an element;
(b) reading a data string located in a designated data field of the ancillary data packet at the element; and
(c) comparing the data string located in the designated data field at the element with a predetermined data string for the designated data field.

8. The method of claim 7 further comprising the step of:
generating an alarm stimulus signal if the data string located in the designated data field is not a match with the predetermined data string for the designated data field at the element.

9. The method of claim 8 wherein the generating an alarm stimulus signal involves notifying a service provider that the data string located in the designated data field is not a match with the predetermined data string.

10. The method of claim 8 wherein the generating an alarm stimulus signal involves notifying a service provider of a location of the element.

11. The method of claim 7 wherein the element is located in a head end of the network.

12. The method of claim 7 wherein the element is a stand alone video test probe.

13. The method of claim 7 wherein the element is selected from a group consisting of a receiver descrambler, a modular receiver decoder, an audio/video signal grooming module and an advertisement media catcher module.

14. The method of claim 7 wherein the element is selected from a group consisting of a video decoder, a delivery server and a set top box.

15. A device for use in detecting a corrupted video stream comprising:
(a) a memory containing a set of instructions for reading a data string located in a designated data field of an ancillary data packet and comparing the data string to a predetermined data string for the designated data field; and
(b) a processor for processing the set of instructions.

16. The device of claim 15 wherein the set of instructions further include instructions for generating an alarm stimulus signal if the data string located in the designated data field is not a match with the predetermined data string for the designated data field.

17. The device of claim 16 wherein the set of instructions further include instructions for notifying a service provider when the data string located in the designated data field is not a match with the predetermined data string.

18. The device of claim 17 wherein notifying the service provider when the data string located in the designated data field is not a match with the predetermined data string involves sending a message to the service provider.

19. The device of claim 16 wherein the set of instructions further include instructions for notifying a service provider of a location of the device.

20. The device of claim 19 wherein notifying the service provider of the location of the device involves sending a message to the service provider.
